(19) United States
(12) Patent Application Publication
(10) Pub. No.: US 2006/0044345 A1
(43) Pub. Date: Mar. 2, 2006

(54) Multimode printhead

(76) Inventors: Morgan Jones, San Diego, CA (US); Jason Arbeiter, Poway, CA (US); Tod Heiles, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/928,487

(22) Filed: Aug. 27, 2004

(51) Int. Cl. B41J 23/00

(52) U.S. Cl. 347/37

(57) ABSTRACT

A printhead capable of printing in multiple print modes is herein disclosed. The printhead includes multiple pens that are movable independent of one another. The collective line of the multiple pens is wider than a sheet of recording media upon which an image is to be printed and provides for at least some overlap between the respective pens. The pens of the printhead may be aligned so as to accommodate malfunctioning printing elements in one or more of the pens. Where malfunctions in the respective pens are such that the pens may not be arranged so as to print an image on the recording media across the full width of thereof, the pens may be arranged to operate as a serial type printhead in which a media handling mechanism moves the recording media past the printhead multiple times to effect printing of the image.

### TECHNICAL FIELD OF THE INVENTION

The present invention relates generally to printheads for incremental printers. More specifically, the present invention relates to a composite printhead for incremental printers that compensates for printhead malfunctions and which can act as a line-type printhead to print in a single pass printmode or as a serial-type printhead to print in a multipass printmode.

### BACKGROUND OF THE INVENTION

Incremental printing devices including inkjet printers of the thermal and piezoelectric varieties, dot matrix printers, impact printers, etc., provide an inexpensive and flexible solution to many printing problems. In particular, when used in a line-type configuration, these types of printing devices (hereinafter referred to as “printers) are capable of high printing throughputs at relatively low costs per page printed. However, the total cost of ownership of such a printer can be fairly high due to the fact that malfunctions in a line-type printing head typically necessitate replacement of the entire printing head. A number of prior art references describe attempts to ameliorate this problem.

U.S. Pat. No. 5,398,053 to Hirosawa, et al. describes the use of an ancillary printhead in addition to a primary, line-type printhead to compensate for printing errors due to malfunctions in the line type printhead. While a single auxiliary printhead allows for printing errors caused by malfunctions in the primary printhead to be corrected, at some point the number and/or position of the errors present in a primary line-type printhead will unduly reduce the rate of throughput and/or the quality of images being printed, thereby necessitating replacement or repair of the primary printhead.

U.S. Pat. No. 6,481,820 to Tamura, et al. discloses a printer having a redundant line-type printhead aligned directly behind a primary printhead for the purpose of compensating for printing errors in the primary printer. The redundant line-type printer will take over the printing functions of the entire primary printhead or selected portions thereof where there are malfunctions in the primary printhead. Tamura also describes a primary line-type printhead that can be moved laterally with respect to a sheet of recording media being printed so that functioning nozzles of the primary print head may print over the portion of the recording media missed due to malfunction in the printhead in a second or third pass. While Tamura's inventions describe means of correcting for at least some degree of malfunction in a print head, the described devices are limited at best. A redundant line-type printhead may also fail and where the failure of the redundant print head is aligned with that of the primary printhead, both printheads will have to be replaced. Malfunctions in a laterally moveable line-type printhead will greatly slow throughput of the printing process as correcting the resulting errors will necessarily require a multiple pass print mode and the limited range of motion of the printhead that results from the width of the printhead will also limit the nature of corrections that may be effected.

U.S. Pat. No. 6,270,187 to Murcia et al. describes a method of operating a malfunctioning line-type printhead so as to optimize the printing process. Murcia describes “cropping” the pen width, i.e. rendering that portion of the pen between the malfunction and the nearest edge inoperable, and then using the functional portion of the printhead to print images on recording media in a multipass printmode. Because the number of passes required is dictated by the location and magnitude of the malfunction in the printhead, it will often be the case that the printmode necessary to accomplish the printing process may not be particularly efficient, thereby resulting in higher costs per page.

Accordingly, there is a recognized need for a line-type print head that is capable of flexibly compensating for one or more malfunctions in a printhead in such a manner as to maintain maximal printing throughput. In addition, where malfunctions in a line-type print head obviate that printhead's ability to print in a single pass printmode, there is a need for a printhead and printing method that can maximize the “swath” with respect to the width of the recording media being printed upon. Such methods and/or mechanisms reduce the total cost of ownership of the printer by putting off the need to immediately replace the printhead or portions thereof, thereby reducing replacement costs of materials and costs arising from improper or interrupted operation of the printer.

### SUMMARY

The needs described above are met in a composite printhead constructed according to the principles of the present invention. Such a printhead generally has two or more printing heads, and preferably three, each having a plurality of printing mechanisms disposed on an operative surface thereof. The printing mechanisms of each of the printing heads are constructed and arranged such that when the printing mechanisms of the printing heads are addressed to a sheet of recording media and upon receiving a control signal from a controller, the printing mechanisms deposit colorant onto the recording media to form an image thereupon. The printing heads are mounted on respective movable guide rail assemblies. The guide rail assemblies render the printing heads independently moveable with respect to one another and are aligned in parallel with one another across the width of the sheet of recording media.

The printing heads are each narrower than the sheet of recording media as measured parallel to the guide rail assemblies, but are collectively wider than the recording media as measured along the guide rail assemblies. In addition, the printing heads are constructed such that there is at least some overlap between the respective printing heads when the printing heads are positioned on the guide rail assemblies in order to form an image on the sheet of recording media.

The printing heads of the printhead are of any type commonly used in incremental type printers, including, but not limited to, thermal and piezoelectric inkjet printers, dot matrix printers, and impact printers.

In use the printing heads may be arranged to print on the recording media in a single pass print mode or in a multipass print mode. When used in its single pass print mode, the printing heads are arranged to print a swath that is wider than a sheet of recording media. When used in its multipass print mode, the printing heads are arranged to print a swath that is narrower than the width of the sheet of recording media. What is more, when arranged in either of its single pass or multipass print modes, the respective printing heads may be arranged such that one or more functional printing mechanisms on one or more of the printing heads may be aligned with one or more nonfunctional printing mechanisms on another of the printing heads.

### BRIEF DESCRIPTION OF THE DRAWINGS

FIG. 1 is a schematic view of a printer that utilizes a composite of line-type printhead according to one embodiment of the invention in conjunction with a rotary drum type media handling mechanism;

FIG. 2 is a schematic view of a printer that utilizes a composite printhead according to one embodiment of the invention in conjunction with a linear type media handling mechanism;

FIG. 3 is a flowchart that describes one mode of operation for a composite printhead of one embodiment of the invention;

FIG. 4 is a schematic diagram of an arrangement of a composite printhead wherein the printhead is accommodating a malfunctioning sector of one of the printheads that make up the composite printhead;

FIG. 5 is a schematic diagram of an arrangement of a composite printhead wherein the printhead is accommodating a malfunctioning sector of one of the printheads that make up the composite printhead;

FIG. 6 is a schematic diagram of an arrangement of a composite printhead wherein the printhead is accommodating a malfunctioning sector of one of the printheads that make up the composite printhead; and,

FIG. 7 is flow chart that describes an alternate mode of operation for the composite printhead of one embodiment of the invention.

### DETAILED DESCRIPTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

While any form of incremental printer may embody the present invention, it will be hereinafter described as it applies to an inkjet style printer. Inkjet printing mechanisms may be used in a variety of different products, such as plotters, facsimile machines and inkjet printers (collectively referred to hereinafter as “printers”) to print images using colorants such inks, dyes, and pigments. These inkjet printing mechanisms use cartridges, often called “pens,” to shoot drops of ink onto a page or sheet of print media. Each pen has at least one printing surface or head that includes very small nozzles through which the ink drops are fired. Multi-color cartridges include several separate printing heads, each of the separate printing heads being connected to an ink reservoir of a different color.

The particular ink ejection mechanism within a printing head may take on a variety of different forms known to those skilled in the art, such as those using piezoelectric or thermal printhead technology. For instance, two earlier thermal ink ejection mechanisms are shown in U.S. Pat. Nos. 5,278,584 and 4,683,481, both assigned to the present assignee, Hewlett-Packard Company and hereby incorporated by reference. In a thermal system, a barrier layer containing ink channels and vaporization chambers is located between a nozzle orifice plate and a substrate layer. This substrate layer typically contains linear arrays of heater elements, such as resistors, which are energized to heat ink within the vaporization chambers. Upon heating, an ink droplet is ejected from a nozzle associated with the energized resistor.

In a serial-type printer the pens are mounted on a carriage, which is arranged to scan across a scan axis relative to a sheet of print media as the pens print a series of individual drops of ink on the print media. The series of drops collectively form a band or “swath” of an image, such as a picture, chart or text. Between scans, the print medium is advanced relative to the scan axis.

Another type of printer, known as a line-type printer, utilizes elongate pens that extend across the entire width of a sheet of print media. Line-type pens are stationary and the sheets of print media are moved relative to the pens to effect printing. Using the terminology set forth above, a line-type printer ejects a series of drops that collectively forms a band or swath that is the width of the entire sheet of print media. Both serial- and line-type printing heads enable an image to be incrementally printed.

The pens of both serial- and line-type printers are typically formed of one or more dies, each die having one or more nozzles for ejecting ink formed thereon. Where one or more nozzles or an entire die of a pen malfunction, the quality of the images printed upon the print media may be degraded. As used herein, the term “malfunction” shall be construed to mean any type of operation that results in degraded print quality or in the complete inoperativeness of a nozzle, group of nozzles, or all of the nozzles on one or all of the dies of a pen or pens.

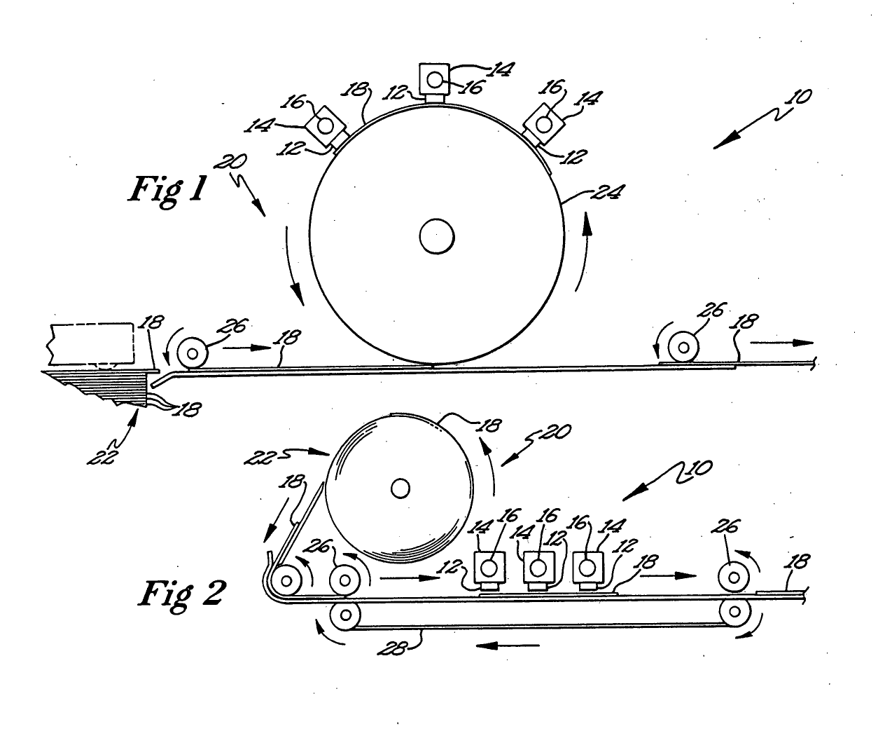

Referring first to FIGS. 1 and 2, one embodiment of a composite printhead 10 can be seen. The printhead 10 is comprised of two or more pens 12, and preferably three pens 12, each of which is mounted on a separate, independently movable printer carriage 14. Each of the printer carriages 14 is in turn mounted upon a guide rail 16. The guide rails 16 are preferably straight, but may be formed in a curvilinear shape should the need arise. A stepper motor and toothed belt or an equivalent mechanism (not shown) is used to move the printer carriage 14 along the guide rail 16. Each of the printer carriages 14 has associated therewith a linear encoder and its appurtenant structure (not shown) for determining the position of the printer carriage 14 upon the guide rail 16. The guide rails 16 of the respective printer carriages 14 are arranged in parallel with one another and generally across the width of a sheet of recording media 18 upon which the pens 12 form an image. While it is preferable to align the guide rails 16 of the respective printer carriages 14 in a perpendicular relation to a primary direction of travel of the sheets of recording media 18, the guide rails 16 may also be aligned at any desired angle so long as the printer carriages 14, and hence the pens 12, may address the entire width of the sheet of recording media 18.

Note that the Figures illustrate printer carriages 14 as having only a single pen 12. It is to be understood however, that the printer carriages 14 may mount multiple pens 12 that are constructed and arranged so as to dispense multiple colors, shades, or hues of colorants. While not necessary, each of the printer carriages 14 may also be provided with two or more pens 12 to dispense the same colorant that act cooperatively to ensure that the selected colorant is dispensed when desired, i.e. a secondary pen (not shown) may be provided to take over printing duties for a primary pen 12, wholly or in part, where the primary pen 12 suffers a malfunction.

Though the preferred embodiment of the printhead 10 described herein includes three printer carriages 14, it is to be understood that the printhead 10 can be comprised of two, three, four, five, or more printer carriages and their respective pens. In all embodiments of the printhead 10, the respective widths of the pens 12 of the printheads 14 are narrower than the width of a sheet of recording media 18. However, the total width of the respective pens 12 is wider than the width of the sheet of recording media 18 being printed. In addition, the total width of the pens 12 of the printhead 10 will exceed the width of the sheet of recording media 18 so as to provide for a predetermined degree of overlap between the pens 12 of the printhead 10. While in one embodiment of the present invention each of the pens 12 are all of identical width, it is contemplated that the pens 12 may have varying widths.

The pens 12 are controlled by an electronic controller (not shown) of a type commonly known to the art. A typical electronic controller is a device capable of receiving, processing, storing and transmitting information from a computer or similar device to printer carriages 14 and pens 12 of the printhead 10. A suitable controller will communicate with a source device such as a desktop computer and will receive data therefrom regarding the nature of the images that are to be printed. Signals from the electronic controller dictate the position and operation of the pens 12 such that the pens 12 form an image on a sheet of recording media 18 as it is passed beneath the printhead 10.

Sheets of recording media 18 are passed beneath the printhead 10 by a media handling mechanism 20. Various types of media handling mechanisms 20 may be used in conjunction with the printhead 10 and it is to be understood that any mechanism capable of controlling recording media 18 so as to enable the printhead 10 to print an image on the recording media 18 will be found suitable. In general, a media handling mechanism 20 will include a media storage apparatus 22 such as a tray for individual sheets of recording media 18 or a roll support mechanism for continuous ribbons or rolls of recording media 18. Recording media 18 may be transferred from the media storage apparatus 22 and passed beneath the printhead 10 by various means known to the art. FIG. 1 illustrates a drum-type media handling mechanism 20 wherein a drum 24 receives a sheet of recording media 18 from a nip roller 26. The recording media 18 is secured to the drum 24 by means of electrostatic force, or in some cases by means of pneumatic devices. The electronic controller coordinates the operation of the media handling mechanism 20 and the printhead 10 so as to cause the printhead 10 to form an image on the recording media 18. Once an image has been formed, the recording media 18 is transferred from the drum 24 to a second nip roller 26 or similar output device.

FIG. 2 illustrates a linear belt-type media handling mechanism 20 wherein a flat belt 28 receives a sheet of recording media 18 from a nip roller 26. The recording media 18 is secured to the flat belt 28 by electrostatic force. As stated above, the electronic controller coordinates the operation of the media handling mechanism 28 and the printhead 10 so as to cause the printhead 10 to form an image on the recording media 18. Once an image has been formed on the recording media 18, the recording media is transferred from the flat belt 28 to a second nip roller 26 or similar output device.

In one embodiment of the present invention, the pens 12 of the printhead 10 are arranged so as to print an image on a sheet of recording media 18 in a single pass of the recording media 18 beneath the printhead 10, i.e. the swath of the printhead encompasses the entire width of the recording media 18 and hence the entire image that is to be printed. In this printing mode, referred to hereinafter as a single pass print mode, the printhead 10 acts as a typical line-type printhead.

In another embodiment of the present invention, the printhead 10 may be arranged so as to print an image on a sheet of recording media 18 in multiple passes. In this printing mode, hereinafter referred to as a multipass print mode, the recording media 18 is passed beneath the printhead 10 multiple times. During each pass of the recording media 18 beneath the printhead 10, the printhead 10 prints a swath of the image on the recording media 18. In its multipass print mode, the swath of the printhead 10 is narrower than the width of the entire image, thereby requiring multiple passes. Because the recording media 18 must be passed beneath the printhead 10 multiple times when printing in its multipass print mode, the media handling mechanism 20 must be constructed and arranged so as to accommodate moving the recording media 18 beneath the printhead 10 multiple times. Note that the embodiments of the media handling mechanism 20 illustrated in FIGS. 1 and 2 may be adapted to operate in conjunction with the printhead 10 in a multipass print mode. Modifications required to enable the printing of discrete sheets of recording media 18 or continuous ribbons of recording media 18 are considered to be within the purview of those skilled in the art.

The dies (not shown) of the pens 12 of the printhead 10 are arranged such that the nozzles thereof are aligned generally parallel with the guide rails 16 of the printer carriages 14. In a preferred embodiment, all the nozzles of each pen 12 are aligned parallel with the guide rail 16 of the printer carriage 14 in which the respective pen 12 is mounted. In an alternate embodiment, the nozzles of each pen 12 may be formed or positioned at an angle to the guide rail 16 of the printer carriage 14.

Each of the printer carriages 14 may have associated therewith a pen maintenance station (not shown). Where printer carriage 14 is provided with a pen maintenance station, the electronic controller will periodically address the pens 12 of the printer carriage 14 to the pen maintenance station to assure the proper operation of the pens 12. Pen maintenance stations are well known in the art and typically comprise a wiping mechanism for scraping deposits from the surface of the dies of each of the pens 12 and an ink reservoir for accepting ink that is ejected from the nozzles of the pens 12. A pen maintenance station may also include a vacuum device for applying a vacuum to the nozzles of the pen 12 for the purpose of removing blockages from the nozzles. See U.S. Pat. No. 6,238,112 to Girones et al., which is commonly assigned with the present invention and which is hereby incorporated by reference.

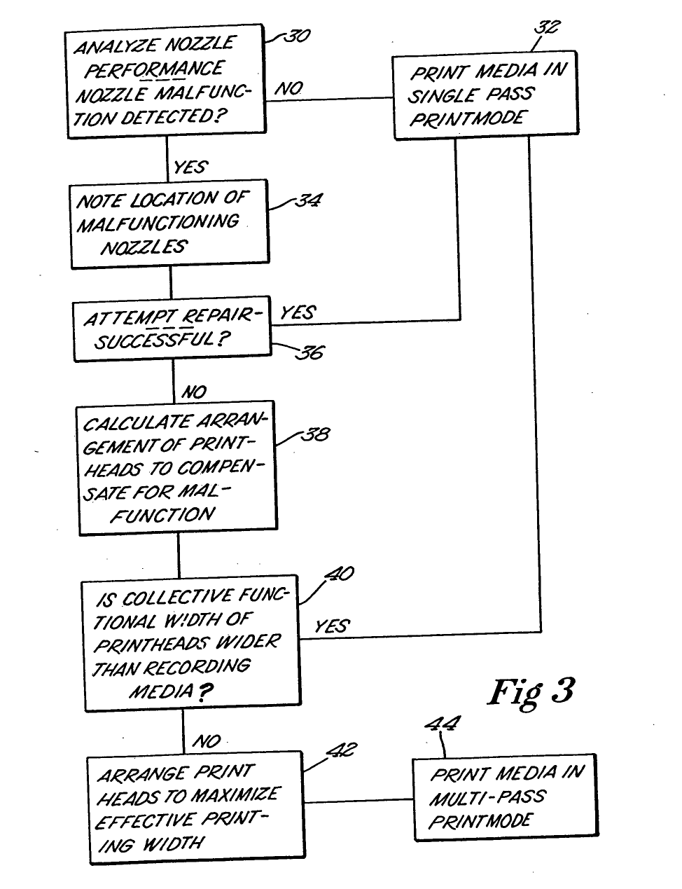

A nozzle function testing apparatus or method is used to analyze the function of the nozzles of the printhead 10. Any suitable apparatus or method designed to determine whether the nozzles of the printhead are functional may be used. One suitable example is disclosed in U.S. Pat. No. 6,238,112 to Girones et al., which was incorporated by referenced hereinabove. Other methods or mechanisms may also be used to identify and record the presence and location of malfunctioning nozzles in the pens 12 of the printhead 10.

Where a malfunctioning nozzle or group of nozzles is detected in one or more of the pens 12, the position of the malfunctioning nozzle(s) is noted and saved in the memory of the electronic controller. When a malfunction is detected, or where the number and/or arrangement of malfunctioning nozzles reaches a predetermined level that corresponds to an unacceptable print quality, the electronic controller will arrange the pens 12 of each of the printer carriages 14 so as to compensate for the malfunctioning nozzle(s). FIG. 3 illustrates a method whereby the printhead 10 may be caused to print an image on a sheet of recording media 18 in such manner as to compensate for malfunctions in one or more nozzles of the pens 12 of the printhead 10.

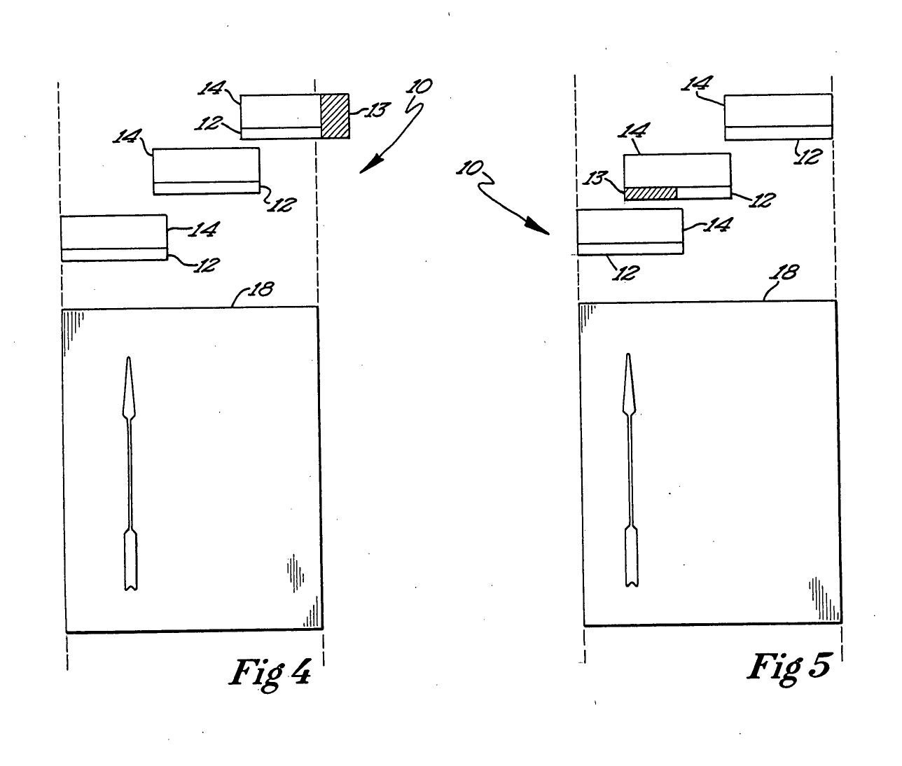

The method of compensating for malfunctions in the pens 12 of the printhead 10 begins with the step of analyzing the performance of the nozzles of the pens 12 as indicated by reference numeral 30 in FIG. 3. Where no malfunctioning nozzles are detected, the electronic controller will select single pass print mode (step 32) for the printhead 10 and will arrange the printer carriages 14 such that the pens 12 will be able to print a swath that is wider than the sheet of recording media 18 being printed upon.

Where one or more malfunctioning nozzles are detected, the next step in the method is to note the location of the malfunctioning nozzles (step 34). Should the printer carriages 14 be provided with pen maintenance stations, the printer carriages 14 having pens 12 with malfunctioning nozzles may be addressed to the pen maintenance stations to ameliorate the malfunction of the nozzles (step 36). Note that step 36 is optional and may be dispensed with or may be undertaken only infrequently, as the application demands. The pens 12 with malfunctioning nozzles will again be analyzed using the nozzle function testing apparatus or method to determine whether the repair attempt was successful. If the repair attempt was successful and there are no malfunctioning nozzles present, the electronic controller will elect to proceed with the printing of the image in a single pass print mode (step 32). Where the attempt to repair the malfunctioning nozzles is not successful, or where the printer carriages 14 are not provided with pen maintenance stations, the electronic controller will calculate an arrangement of the pens 12 of the printer carriages 14 that will compensate for the malfunctioning nozzle(s) (Step 38). FIGS. 4-6 illustrates various exemplary arrangements of the pens 12 of the printer carriages 14 that compensate for malfunctioning nozzles in the pens 12.

The parameters used to calculate the arrangement of the pens 12 of the printer carriages 14 will differ from application to application. However, two relevant parameters in determining the arrangement of the pens 12 are the rate at which images can be printed on the recording media 18 (hereinafter “throughput) and the print quality of the images printed on the recording media 18. As a single pass print mode will generally allow for the highest throughput, in one embodiment the electronic controller will arrange the pens 12 of the printhead 10 so as to enable a single pass print mode. In this embodiment the controller will determine whether an arrangement of the pens 12 exists that will be wider than the width of the recording media 18. Keep in mind that for a given set of pens 12 having a given arrangement of malfunctioning nozzles, there may be multiple arrangements of the pens 12 that will permit the use of a single pass print mode. The electronic controller may choose the appropriate arrangement of the pens 12 from a predetermined list of pen arrangements stored in the memory of the electronic controller, or may calculate the most efficient arrangement for the pens 12 based on the number and position of the malfunctioning nozzles of the pens 12 of the printhead 10. The term “arrangement” is to be construed so as to mean not only the positioning of the pens 12 of the printhead 10, but also the ordering of the movements of the printer carriages 14 in positioning the pens 12. Accordingly, in some circumstances it may turn out that the pens 12 must be moved in a complex pattern with respect to the recording media 18 to enable the printing of an image. In these circumstances, it is to be understood that the arrangement of the pens 12 also includes the pattern in which the pens 12 are moved.

By way of example only, and without limiting the scope of the present invention, FIG. 4 illustrates an arrangement of the pens 12 of three carriages 14 to compensate for a group 13 of malfunctioning nozzles in the pen 12 of the right most carriage 14. The malfunctioning nozzles 13 may represent a single malfunctioning nozzle or malfunction in all the nozzles of a die of the pen 12. In any case, the carriages 14 of the printhead 10 are arranged such that the functional portions of the pens 12 cover the width of the recording media 18. The amount by which the total width of the pens 12 exceed the width of the sheet of recording media 18 may be correlative of the printhead's 10 ability to compensate for malfunctioning nozzles in its pens 12, i.e. it may well be desirable to maximize the overlap between the respective pens 12 so as to increase the ability of the printhead 10 to compensate for nozzle malfunction.

As can be seen in FIG. 4, the right most carriage 14 has been positioned such that the group 13 of malfunctioning nozzles in the pen 12 of that carriage is positioned outboard of the sheet of recording media 18. The remaining carriages 14 have been positioned so that their respective pens 12 cover the remainder of the width of the sheet of recording media 18, thereby enabling printing of the recording media 18 in a single pass print mode.

Similarly, FIG. 5 illustrates an arrangement of the printer carriages 14 of the printhead 10 to compensate for a group 13 of malfunctioning nozzles in the center carriage 14. Note that each of the carriages 14 may be positioned laterally anywhere across the width of the guide rail 16 upon which it is mounted and accordingly anywhere across the width of the sheet of recording media 18. The left most carriage 14 in FIG. 5 has been positioned so as to overlap the group 13 of malfunctioning nozzles in the center carriage 14. The right most carriage 14 has been positioned to print the remainder of the sheet of recording media 18. The arrangement illustrated in FIG. 5 is sufficient to permit the printing of the recording media 18 in a single pass print mode. However, should the group 13 of malfunctioning nozzles have been wide enough such that a collective functional width of the pens 12, that is, the width of the swath that the pens 12 can collectively print, was narrower than the width of the recording media 18, the printhead 10 would then be operated in a multipass print mode. Generally speaking, where the printhead 10 will be operating in a multipass print mode, the arrangement of the printer carriages 14 will be specified so as to maximize the collective functional width of pens 12. In this way, the number of passes required to print an image on a sheet of recording media 18 will be minimized, thereby maximizing the throughput of the printing process. Alternatively, where the printhead 10 is to be operated in a multipass print mode, the arrangement of the printer carriages 14 may be specified so as to minimize the amount of movement required by the carriages 14 to effect the printing of an image on a sheet of recording media 18. In some instances, minimizing the amount of movement required by the carriages 14 may actually improve the throughput of the printing process even where the recording media 18 must be passed beneath the printhead 10 additional times.

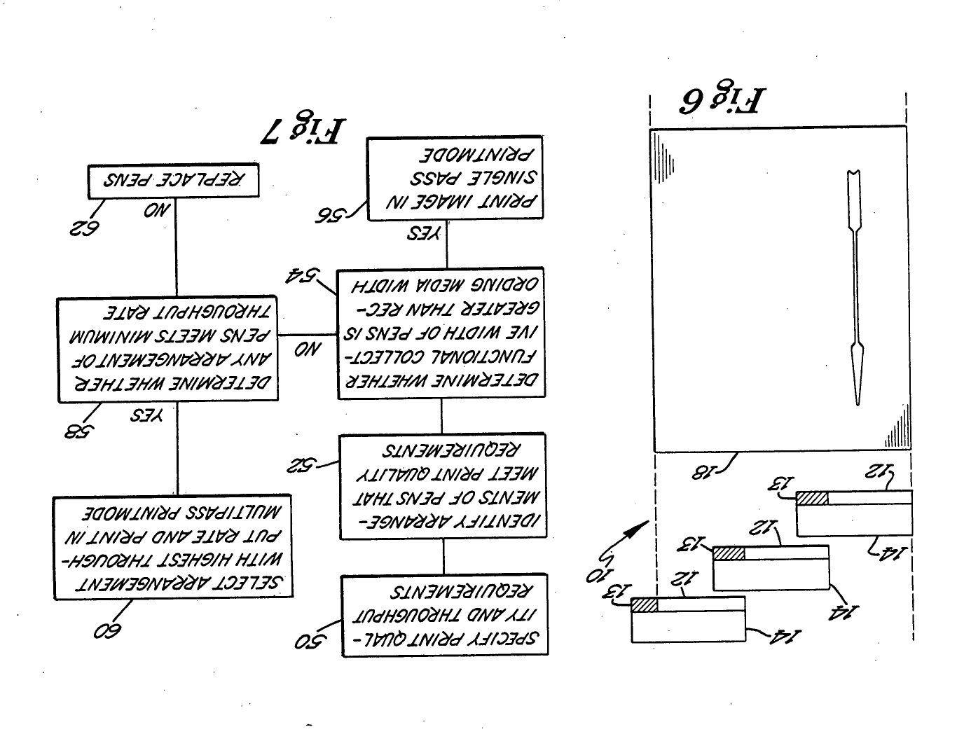

FIG. 6 illustrates an arrangement of the printer carriages 14 of the printhead 10 that compensates for multiple groups 13 of malfunctioning nozzles in the pens 12 of the printer carriages 14. Note that in this arrangement of the printer carriages 14 of the printhead 10, the printer carriages 14 are arranged so that a functional aspect of a pen 12 will overlap a group 13 of malfunctioning nozzles in another pen 12 such that functioning nozzles of overlapping pen 12 will be able to print in lieu of the malfunctioning nozzles. As shown, the printer carriages 14 are arranged so as to effect the printing of an image on a sheet of recording media 18 in a single pass print mode. However, as described in conjunction with FIG. 5, should the collective functional width of the pens 12 of the printhead 10 be less than the width of the recording media 18, and the carriages 14 of the printhead 10 will be arranged so as to print an image on the recording media 18 in a multipass print mode.

Generally speaking, where an image to be printed upon a sheet of recording media 18 is narrower than the collective functional width of the pens 12 of the printhead 10, that image may be printed upon the recording media 18 in a single pass print mode even where the collective functional width of the pens 12 is less than the total width of the recording media 18. The width of the image to be printed on the recording media 18 is monitored by the electronic controller which will determine whether the image may be printed in a single pass print mode or in a multipass print mode (step 40 in FIG. 3). Where the collective functional width of the pens 12 of the printhead 10 exceeds the width of the image, printing proceeds in a single pass print mode (step 32), and where the collective functional width of the pens 12 of the printhead 10 is less than the width of the image to be printed, the printer carriages 14 of the printhead 10 will be arranged to maximize the collective functional width of the printhead 10 (step 42). Once step 42 has been accomplished, printing , of an image on the recording media 18 proceeds in a multipass print mode (step 44).

Under certain circumstances it may be possible for the pens 12 to print an image upon the recording media 18 (in either single or multipass print mode), but in a print quality that is unacceptable for the application to which the printhead 10 has been put. In these circumstances, it will be necessary to recalculate the positioning of the printer carriages 14 so as to improve the print quality. While it is possible to calculate the positions of the printer carriages 14 such that one or more functional nozzles on a pen 12 are aligned with a nonfunctional nozzle on a separate pen 12, thereby insuring that printing occurs across the entire functional width of the printhead 10, it is also the case that an acceptable print quality may be obtained without compensating for every single malfunctioning nozzle in the pens 12 of the printhead 10. Therefore, the arrangement of the printer carriages 14 will be such that in addition to maximizing the throughput of the printing operation, the print quality output by the printhead 10 will also be maximized. By way of example only, a single malfunctioning nozzle in a pen 12 may not give rise to an unacceptable print quality, whereas two or more adjacent malfunctioning nozzles will. In this case it would be acceptable align one or more functional nozzles with one, two or more of the malfunctioning nozzles to obtain an acceptable print quality. It would not be absolutely required in this example to align one or more functional nozzles with all of the malfunctioning nozzles to appropriately compensate for the malfunctioning nozzles.

Note that the degree to which either throughput or print quality may control of the arrangement of the printer carriages 14 may be varied from application to application. For example, where high-quality images are to be printed in a magazine or on photographic paper, the criteria of print quality may be paramount. Conversely, where single color label stock is to be printed, print quality may be discounted in favor of maximizing throughput of the printing operation.

FIG. 7 depicts an exemplary method whereby the pens 12 may be arranged with respect to print quality and throughput requirements. Note that the process illustrated in FIG. 7 may be combined with the method illustrated in FIG. 3. What is more, the order in which certain criteria are considered in determining the arrangement of the pens 12 may also be reversed and other criteria may be introduced or may replace the criteria called out in FIG. 7. Print quality and throughput requirements are specified as shown in step 50 of FIG. 7. The criteria needed to determine whether print quality and throughput requirements have been met may be specified directly by the user of a printer or may be calculated directly from data output by the printer. For example, one aspect of a satisfactory print quality may be that the density of malfunctioning nozzles for a given length of a pen 12 is below a certain threshold and/or to malfunctioning nozzles are not permitted to be located side-by-side. For any given arrangement of the pens 12, it should be relatively simple to calculate the throughput rates of the printing operation based on the rates at which recording media 18 may be moved through the printer, number of passes required to print the recording media 18, and any time lag generated by the movement of the printer carriages 14 in positioning the pens 12.

In the embodiment illustrated in FIG. 7, once print quality and throughput requirements have been stated, those arrangements of the pens 12 that satisfy the print quality requirements are identified (step 52). Note that this identification step should take place after all malfunctioning nozzles in the pens 12 have been identified and their locations noted, as described in steps 34 and 36 (see FIG. 3). These arrangements of the pens 12 of an assessed to determine whether the functional collective width of the pens is greater than the width of the recording media 18 (step 54). Where the functional collective width of the pens 12 is greater than the width of the recording media 18 in at least one of the arrangements determined in step 52, 1 of the arrangements that satisfy the print quality requirements will be selected and an image will be printed on the recording media 18 using a single pass print mode. But where the functional collective width of the pens 12 is less than the width of the recording media 18, it must be determine whether any of the arrangements identified in step 52 will satisfy the throughput requirements set forth in step 50 when images are printed on the recording media 18 in a multipass print mode. In step 58 the throughput rates that would result from the arrangements identified in step 52 are calculated and assessed determine whether at least one of the arrangements of the pens 12 exceeds the minimum throughput rate. Where at least one of the arrangements of the pens 12 satisfies the minimum throughput requirement, but the functional collective width of the pens 12 is less than that of the recording media 18, images will be printed on the recording media 18 a multipass print mode in which the arrangement of the pens 12 having the largest throughput rate will be selected. Where none of the arrangements of the pens 12 identified in step 52 satisfy the minimum throughput rates as determined in step 58, it will be necessary to replace sufficient of the pens 12 to enable the printhead 10 to satisfy the print quality and throughput requirements.

Although specific embodiments of the present invention have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

What is claimed is:

1. A composite printhead comprising:
at least three inkjet pens, each having a plurality of ink dispensing nozzles aligned on an operative surface thereof, the nozzles of each of the inkjet pens being constructed and arranged such that when the nozzles of the inkjet pens are addressed to a sheet of recording media and upon receiving a control signal from a controller, the nozzles of each inkjet pen will dispense a colorant therefrom onto the sheet of recording media to form an image thereupon;
at least three guide rail assemblies, each of the guide rail assemblies being constructed and arranged for moveably mounting a respective inkjet pen thereon, each of the inkjet pens being independently moveable with respect to one another, the respective guide rails being aligned in parallel with one another across the width of the sheet of recording media; and,
wherein each of the inkjet pens has a width that is less than the width of the sheet of recording media as measured parallel to the guide rail assemblies, the inkjet pens being collectively wider than the width of the recording media as measured parallel to the guide rail assemblies, the width of the inkjet pens further being such that there is at least some overlap between the respective inkjet pens when the inkjet pens are positioned on the guide rail assemblies in order to form an image on the sheet of recording media.

2. The composite printhead of claim 1 wherein the at least three inkjet pens are arranged so as to form an image on the sheet of recording media as the sheet of recording media is passed beneath the at least three printheads a single time.

3. The composite printhead of claim 1 wherein the respective inkjet pens may be arranged such that at least one functional nozzle of at least one of the respective printheads may be aligned with a nonfunctional nozzle of one other of the inkjet pens so as to permit the at least three inkjet pens to compensate for at least some nonfunctional nozzles and to form an image on the sheet of recording media as the sheet of recording media is passed beneath the at least three printing heads.

4. The composite printhead of claim 3 wherein the at least three inkjet pens are arranged so as to form the image on the sheet of recording media in a single pass of the sheet of recording media past the at least three inkjet pens.

5. The composite printhead of claim 3 wherein the at least three inkjet pens are arranged so as to form the image on the sheet of recording media in multiple passes of the sheet of recording media beneath the at least three inkjet pens.

6. The composite printhead of claim 3 wherein the sheet of recording media is passed beneath the at least three print heads multiple times by a media handling mechanism.

7. The composite printhead of claim 1 wherein the sheet of recording media is passed beneath the at least three print heads by a media handling mechanism, wherein the media handling means is constructed and arranged to move the sheet of recording media beneath the composite printing mechanism multiple times.

8. The composite printhead of claim 1 wherein the sheet of recording media is passed beneath the at least three print heads by a media handling means.

9. A method of compensating for malfunctioning nozzles in a printhead, the method comprising the steps of:
providing a composite printhead that comprises at least three independently movable inkjet pens having a plurality of nozzles for expelling a colorant therefrom, each of the inkjet pens having a width that is smaller than the width of a sheet of recording media that is to be printed by the inkjet pens, the collective width of the inkjet pens being wider than the width of the sheet of recording material, there being at least some overlap between the respective inkjet pens;
providing a means for analyzing the performance of the nozzles of the inkjet pens;
determining the location of all nozzles of the at least three inkjet pens that are malfunctioning and recording those locations; and,
arranging the at least three inkjet pens so as to print an image on the sheet of recording material wherein at least one functional nozzle of at least one of the at least three inkjet pens is aligned with and prints for, a malfunctioning nozzle of another of the at least three inkjet pens.

10. The method of compensating for malfunctioning nozzles in a printhead of claim 9 further including the steps of:
specifying a minimum print quality requirement and a minimum printing throughput value;
identifying all inkjet pen arrangements that meet the print quality requirement; and,
determining whether a functional collective width of the at least three inkjet pens extends wider than an image to be printed on the sheet of recording media and if so, printing the image in a single pass of the sheet of recording media beneath the at least three inkjet pens.

11. The method of compensating for malfunctioning nozzles in a printhead of claim 9 further including the steps of:
specifying a minimum print quality requirement and a minimum printing throughput value;
identifying all arrangements of the at least three inkjet pens that meet the print quality requirement;
determining whether a functional collective width of the at least three inkjet pens extends wider than an image to be printed on the sheet of recording media and if not, then determining whether any arrangements of the at least three inkjet pens satisfies the minimum printing throughput value; and,
printing the image in multiple passes of the sheet of recording media beneath the at least three inkjet pens using an arrangement of the at least three inkjet pens that meets the minimum printing throughput requirement and if no arrangement of the at least three inkjet pens meets the minimum printing throughput requirement, then replacing sufficient of the at least three inkjet pens so as to ensure that there is at least one arrangement of the at least three inkjet pens that satisfies both satisfies the print quality requirement and exceeds the minimum printing throughput value.

12. The method of compensating for malfunctioning nozzles in a printhead of claim 9 further including the steps of:
specifying a minimum print quality requirement and a minimum printing throughput value;
identifying all arrangements of the at least three inkjet pens that exceed the minimum printing throughput value;
determining whether a functional collective width of the at least three inkjet pens extends wider than an image to be printed on the sheet of recording media and if not, then determining whether any arrangements of the at least three inkjet pens satisfies the minimum print quality requirement; and,
printing the image in multiple passes of the sheet of recording media beneath the at least three inkjet pens using an arrangement of the at least three inkjet pens that meets the minimum print quality requirement and if no arrangement of the at least three inkjet pens meets the minimum printing throughput requirement, then replacing sufficient of the at least three inkjet pens so as to ensure that there is at least one arrangement of the at least three inkjet pens that satisfies both satisfies the print quality requirement and exceeds the minimum printing throughput value.

13. The method of compensating for malfunctioning nozzles in a printhead of claim 9 wherein the at least three inkjet pens are arranged such that a functional collective width of the at least three inkjet pens extends wider than an image to be printed on the sheet of recording media and the image is printed in a single pass of the sheet of recording media beneath the at least three inkjet pens.

14. The method of compensating for malfunctioning nozzles in a printhead of claim 9, further including the step of:
determining whether a functional collective width of the at least three inkjet pens is wider than that of an image to be printed on the sheet of recording media.

15. The method of compensating for malfunctioning nozzles in a printhead of claim 14, further including the step of:
arranging the at least three inkjet pens so as to maximize the functional collective width thereof.

16. A composite printhead comprising:
at least three printing heads, each having a plurality of printing mechanisms disposed on an operative surface thereof, the printing mechanisms of each of the printing heads being constructed and arranged such that when the printing mechanisms of the printing heads are addressed to a sheet of recording media and upon receiving a control signal from a controller, the printing mechanisms of each printing head will cause a colorant to be deposited onto the sheet of recording media to form an image thereupon;
at least three guide rail assemblies, each of the guide rail assemblies being constructed and arranged for moveably mounting a respective printing head thereon, each of the printing heads being independently moveable with respect to one another, the respective guide rails being aligned in parallel with one another across the width of the sheet of recording media; and,
wherein each of the printing heads has a width that is less than the width of the sheet of recording media as measured parallel to the guide rail assemblies, the printing heads being collectively wider than the width of the recording media as measured parallel to the guide rail assemblies, the width of the printing heads further being such that there is at least some overlap between the respective printing heads when the printing heads are positioned on the guide rail assemblies in order to form an image on the sheet of recording media.

17. The composite line-type printing mechanism of claim 16 wherein the respective printing heads may be arranged such that at least one functional printing mechanism of at least one of the printing heads may be aligned with a nonfunctional printing mechanism of one other of the printing heads so as to permit the at least three printing heads to compensate for at least some nonfunctional printing mechanisms and to form an image on the sheet of recording media as the sheet of recording media is passed beneath the at least three printing heads.

18. The composite line-type printing mechanism of claim 16 wherein the printing heads are one of an inkjet pen and an impact printer head.

19. A composite line-type printing mechanism comprising:
three discrete and independently moveable print carriages, each of the carriages being moveably mounted upon its own guide rail, the guide rails of the printing mechanism being disposed in parallel relation to one another at a predetermined offset distance and generally perpendicular to a primary media travel direction in which a recording media is moved in relation to the printing mechanism;
at least one inkjet pen mounted in each of the print carriages, each of the inkjet pens comprising at least one printhead having a plurality of ink dispensing nozzles aligned on an operative surface thereof, the inkjet pens of the print carriages being disposed within the print carriages such that the nozzles of the inkjet pens are substantially parallel with the guide rails such that when the operative surfaces of the pens are addressed to a recording media and upon receiving a control signal from a controller, the pens will dispense ink from their ink dispensing nozzles onto the recording media to form an image thereupon;
the at least one inkjet pen of each print carriage having a width that is less than the width of the recording media as measured parallel to the guide rails, the width of the inkjet pens being collectively wider than the width of the recording media as measured parallel to the guide rails, the width of the pens being such that there is at least some overlap between the respective pens when the pens are positioned for printing on the recording media.

20. The composite line-type printing mechanism of claim 19 wherein:
a first of the three print carriages is positioned over the recording media so as to enable the pen mounted therein to form an image over a leftmost portion of the recording media;
a second of the three print carriages is positioned over the recording media so as to enable the pen mounted therein to form an image over a rightmost portion of the recording media; and,
a third of the three print carriages is positioned over the recording media so as to enable the pen mounted therein to form an image over the region of the recording media located between the rightmost and leftmost portions of the recording media;
the overlap of the pens of the respective carriages being constructed and arranged such that where one or more of the nozzles of one or more of the pens malfunctions, the respective pens may be arranged across the width of the recording media so as to compensate for the malfunctioning nozzle or nozzles, the malfunctioning nozzle or nozzles being first rendered inoperative by the controller.

21. The composite line-type printing mechanism of claim 19 further comprising a plurality of linear encoders, each of the linear encoders being communicatively coupled to the controller and emplaced adjacent to the respective print carriages, the linear encoders being constructed and arranged to output data to the controller regarding the position of the respective print carriages relative to the recording media.

22. The composite line-type printing mechanism of claim 21 further comprising a plurality of drive mechanisms, each one of the drive mechanisms being coupled to a respective print carriage, the drive mechanisms being constructed and arranged to position the respective print carriages in a predetermined location relative to the recording media.

23. The composite line-type printing mechanism of claim 19 wherein the print carriages includes multiple pens.

24. The composite line-type printing mechanism of claim 23 wherein each of the multiple pens dispense inks of differing color.

25. The composite line-type printing mechanism of claim 19 wherein the three carriages are constructed and arranged to print an image on the recording media in a single pass.

26. The composite line-type printing mechanism of claim 19 further comprising a recording media handling mechanism that moves the recording media beneath the carriages of the printing mechanism so as to permit the pens of the carriages to print an image on the recording media.

27. The composite line-type printing mechanism of claim 26 wherein the recording media handling mechanism is one of a belt driven feed mechanism and a drum feed mechanism.

28. The composite line-type printing mechanism of claim 27 wherein the print carriages are constructed and arranged such that the pens thereof may be caused to print an image on a recording media in one of a single pass and multiple passes without structural modification.

29. The composite line-type printing mechanism of claim 19 further comprising a nozzle testing apparatus for determining whether the nozzles of the pens are functioning according to a predetermined specified standard, the nozzle testing apparatus being communicatively coupled to the controller, the nozzle testing apparatus transmitting data to the controller regarding the position of any malfunctioning nozzles present in any of the pens of the print carriages.

30. The composite line-type printing mechanism of claim 28 further comprising a nozzle recovery apparatus constructed and arranged to interact with the pens of the print carriages in such a manner as to repair the function of any malfunctioning nozzles.

31. A composite line-type printing mechanism comprising:
a plurality of discrete and independently moveable print carriages, each of the carriages being moveably mounted upon its own guide rail, the guide rails of the printing mechanism being disposed in parallel relation to one another at a predetermined offset distance and generally perpendicular to a primary media travel direction in which a recording media is moved in relation to the printing mechanism;
at least one inkjet pen mounted in each of the print carriages, each of the inkjet pens comprising at least one printhead having a plurality of ink dispensing nozzles aligned on an operative surface thereof, the inkjet pens of the print carriages being disposed within the print carriages such that the nozzles of the inkjet pens are substantially parallel with the guide rails such that when the operative surfaces of the pens are addressed to a recording media and upon receiving a control signal from a controller, the pens will dispense ink from their ink dispensing nozzles onto the recording media to form an image thereupon;
the inkjet pen of each print carriage having a width that is less than the width of the recording media as measured parallel to the guide rails, the width of the inkjet pens being collectively wider than the width of the recording media as measured parallel to the guide rails, the width of the pens being such that there is at least some overlap between the respective pens when the pens are positioned for printing on the recording media.

32. The composite line-type printing mechanism of claim 31 wherein the recording media handling mechanism is one of a belt driven feed mechanism and a drum feed mechanism.

33. The composite line-type printing mechanism of claim 32 wherein the print carriages are constructed and arranged such that the pens thereof may be caused to print an image on a recording media in one of a single pass mode and a multiple pass mode without structural modification.

34. A composite printhead comprising:
at least two inkjet pens, each having a plurality of ink dispensing nozzles aligned on an operative surface thereof, the nozzles of each of the inkjet pens being constructed and arranged such that when the nozzles of the inkjet pens are addressed to a sheet of recording media and upon receiving a control signal from a controller, the nozzles of each inkjet pen will dispense a colorant therefrom onto the sheet of recording media to form an image thereupon;
at least two guide rail assemblies, each of the guide rail assemblies being constructed and arranged for moveably mounting a respective inkjet pen thereon, each of the inkjet pens being independently moveable with respect to one another, the respective guide rails being aligned in parallel with one another across the width of the sheet of recording media; and,
wherein each of the inkjet pens has a width that is less than the width of the sheet of recording media as measured parallel to the guide rail assemblies, the inkjet pens being collectively wider than the width of the recording media as measured parallel to the guide rail assemblies, the width of the inkjet pens further being such that there is at least some overlap between the respective inkjet pens when the inkjet pens are positioned on the guide rail assemblies in order to form an image on the sheet of recording media.

35. The composite printhead of claim 34 wherein the at least two inkjet pens are arranged so as to form an image on the sheet of recording media as the sheet of recording media is passed beneath the at least two printheads a single time.

36. The composite printhead of claim 34 wherein the respective inkjet pens may be arranged such that at least one functional nozzle of at least one of the respective printheads may be aligned with a nonfunctional nozzle of one other of the inkjet pens so as to permit the at least two inkjet pens to compensate for at least some nonfunctional nozzles and to form an image on the sheet of recording media as the sheet of recording media is passed beneath the at least two printing heads.

37. The composite printhead of claim 36 wherein the at least two inkjet pens are arranged so as to form the image on the sheet of recording media in a single pass of the sheet of recording media past the at least two inkjet pens.

38. The composite printhead of claim 36 wherein the at least two inkjet pens are arranged so as to form the image on the sheet of recording media in multiple passes of the sheet of recording media beneath the at least two inkjet pens.

39. The composite printhead of claim 36 wherein the sheet of recording media is passed beneath the at least two print heads multiple times by a media handling mechanism.

40. The composite printhead of claim 34 wherein the sheet of recording media is passed beneath the at least two print heads by a media handling mechanism, wherein the media handling means is constructed and arranged to move the sheet of recording media beneath the composite printing mechanism multiple times.

41. The composite printhead of claim 34 wherein the sheet of recording media is passed beneath the at least two print heads by a media handling means.
